(19) United States
(12) Patent Application Publication
(10) Pub. No.: US 2022/0358113 A1
(43) Pub. Date: Nov. 10, 2022

(54) METHOD OF DISPLAYING DATA

(71) Applicant: BRIGHTN, Inc., Seoul (KR)

(72) Inventor: Jae Hun JEONG, Seoul (KR)

(73) Assignee: BRIGHTN, Inc., Seoul (KR)

(21) Appl. No.: 17/315,944

(22) Filed: May 10, 2021

(51) Int. Cl. G06F 16/23; G06F 16/22; G06F 16/21; G06F 3/0481

(52) U.S. Cl. CPC G06F 16/2358; G06F 16/2246; G06F 16/219; G06F 3/04817

(57) ABSTRACT

A non-transitory computer-readable storage medium includes a user interface configured to display data when a computer program stored in the non-transitory computer-readable storage medium is executed by one or more processors of a computing device; a version tree layer included in the user interface and configured to display a version tree including a main tree composed of one or more versions and a subtree composed of one or more subversions; and a data display layer included in the user interface and configured to display data corresponding to a selectively inputted subversion in response to a selective input for at least one subversion included in the version tree.

### BACKGROUND

### 1. Technical Field

The present disclosure relates to a method of displaying data, and more particularly, to a method of displaying data corresponding to a plurality of versions.

### 2. Related Art

In recent years, data sharing is mostly done online. Companies often work on data shared through online messengers or company intranets. There may be multiple versions of data shared among users. When there are multiple versions, users manage the versions by displaying a version number on a title of the data.

However, when the versions of data are managed by writing the versions to the titles, it is difficult to check how the versions are derived based on which data or which version is finally selected.

In a case of design work and so on in particular, a plurality of versions are often derived from one version. When the plurality of versions are generated, it may be difficult to identify different parts between the versions.

Accordingly, there is a need in the art to effectively display data corresponding to the plurality of versions on a user interface and to increase convenience for management of versions of users.

Korean Patent Application Publication No. 10-2019-0092354 discloses a communication method using an image for a messenger program.

### SUMMARY

The present disclosure provides a method of displaying data.

An embodiment of the present disclosure provides a computer-readable storage medium. The computer-readable storage medium may include a user interface configured to display data when a computer program stored in the computer-readable storage medium is executed by one or more processors of a computing device; a version tree layer included in the user interface and configured to display a version tree including a main tree composed of one or more versions and a subtree composed of one or more subversions; and a data display layer included in the user interface and configured to display data corresponding to a selectively inputted subversion in response to a selective input for at least one subversion included in the version tree.

In an alternative embodiment of computer program operations for performing following operations to display data, two or more versions included in the main tree may have a precedence relationship, and the two or more subversions included in the subtree have a parallel relationship.

In an alternative embodiment of computer program operations for performing following operations to display data, each of the one or more versions included in the main tree may be a subversion selected from the one or more subversions included in the subtree.

In an alternative embodiment of computer program operations for performing following operations to display data, the version tree layer may display only versions corresponding to the main tree in response to a simple view input for viewing a simplified version tree.

In an alternative embodiment of computer program operations for performing following operations to display data, the version tree layer may display a major update on a version of data having a change of more than a threshold when compared with data of a previous version.

In an alternative embodiment of computer program operations for performing following operations to display data, the version tree layer may display only versions corresponding to the major update except for versions not corresponding to the major update, in response to a major update view input for viewing simplified versions corresponding to the major update.

In an alternative embodiment of computer program operations for performing following operations to display data, the user interface may further include a data comparison layer configured to compare two or more pieces of data corresponding to the two or more versions, respectively, and display the compared results in response to a comparison input for the two or more versions included in the version tree to compare the two or more pieces of data.

In an alternative embodiment of computer program operations for performing following operations to display data, the data comparison layer may overlap and displays first data corresponding to a first version and second data corresponding to a second version, the first data may be displayed on an upper side in one region based on an axis such that the second data is not displayed and the second data may be displayed on an upper side in another region based on the axis such that the first data is not displayed, and a size of the one region in which the first data is displayed on the upper side may be expanded to be displayed, and a size of another region in which the second data is displayed on the upper side may be reduced to be displayed in response to a movement input for moving the axis.

In an alternative embodiment of computer program operations for performing following operations to display data, the data comparison layer may adjust a visualization method for at least one of first data corresponding to the first version and the second data corresponding to the second version and may display the adjusted visualization method in response to an adjustment input regarding a visualization adjustment object.

In an alternative embodiment of computer program operations for performing following operations to display data, the data comparison layer may adjust the visualization method for at least one of the first data and the second data in response to an adjustment input in a direction different from the movement input, regarding the visualization adjustment object displayed on the axis.

In an alternative embodiment of computer program operations for performing following operations to display data, the data comparison layer may display annotations for a changed portion between data.

In an alternative embodiment of computer program operations for performing following operations to display data, the processor may generate data of a new version to which change content of a portion corresponding to a change confirmation input among the one or more annotations is applied, in response to the change confirmation input for an annotation.

In an alternative embodiment of computer program operations for performing following operations to display data, the version tree layer may update the version tree such that the new data is included in a position corresponding to the version input and display the updated version tree, based on the new data and a version input for the new data.

In an alternative embodiment of computer program operations for performing following operations to display data, the version tree layer for updating the version tree such that a subversion of the new data is included in a position corresponding to a connection input and displays the updated version tree, in response to a connection input for connecting new data to at least one of a version and a subversion included in the version tree.

In an alternative embodiment of computer program operations for performing following operations to display data, the version tree layer may display a comment object on at least some versions of the one or more versions, and the user interface may further include a comment display layer for displaying comments included in the version tree in response to a comment view input for viewing comments.

Another embodiment of the present disclosure provides a method of displaying data in a user terminal. The method of displaying data may include displaying a version tree including a main tree composed of one or more versions and a subtree composed of one or more subversions, on a version tree layer; and displaying data corresponding to the subversion that is selectively inputted on a data display layer in response to a selective input for at least one subversion included in the version tree.

Another embodiment of the present disclosure provides a user terminal. The user terminal may include a processor including one or more cores; a memory; and an output unit configured to provide a user interface, wherein the user interface includes a version tree layer configured to display a version tree including a main tree composed of one or more versions and a subtree composed of one or more subversions; and a data display layer configured to display data corresponding to a selectively inputted subversion in response to a selective input for at least one subversion included in the version tree.

### BRIEF DESCRIPTION OF THE DRAWINGS

Various embodiments of the present disclosure will become more apparent in view of the attached drawings and accompanying detailed description, in which:

FIG. 1 is a block diagram of a computing device that performs an operation of providing a method of displaying data according to an embodiment of the present disclosure;

FIG. 2 is an example diagram of a version tree layer and a data display layer according to an embodiment of the present disclosure;

FIG. 3 is an example diagram of a version tree according to an embodiment of the present disclosure;

FIG. 4 is an example diagram of a version tree according to an embodiment of the present disclosure;

FIG. 5 is an example diagram of a version tree according to an embodiment of the present disclosure;

FIGS. 6A and 6B are example diagrams of a data comparison layer according to an embodiment of the present disclosure;

FIG. 7 is another example diagram of the data comparison layer according to an embodiment of the present disclosure;

FIG. 8 is an example diagram of a comment display layer according to an embodiment of the present disclosure;

FIG. 9 is a flowchart for providing a method of displaying data, according to an embodiment of the present disclosure; and

FIG. 10 is a block diagram of a computing device according to an embodiment of the present disclosure.

### DETAILED DESCRIPTION OF THE EMBODIMENTS

Various embodiments are now described with reference to the drawings. In the present specification, various descriptions are presented to provide understanding of the present disclosure. However, it is clear that the embodiments may be implemented without the specific

### DESCRIPTION

As used herein, terms “component”, “module”, “system” or the like refer to a computer-related entity, hardware, firmware, software, a combination of software and hardware, or execution of software. For example, a component may be a procedure performed by a processor, a processor, an object, a thread of execution, a program, and/or a computer but is not limited thereto. For example, both an application running on a computing device and a computing device may be components. One or more components may be provided in a processor and/or a thread of execution. One component may be localized within a single computer. One component may be distributed between two or more computers. In addition, the component may be executed by various computer-readable media having various data structures stored therein. Components may communicate with each other through local and/or remote processing, for example according to a signal (for example, data from one component interacting with another component in a local system or a distributed system, and/or data transmitted to another system using signals through a network such as the Internet) having, for example, one or more data packets.

In addition, a term “or” is intended to mean an inclusive “or” and not an exclusive “or”. That is, unless specified otherwise or is not clear from a context, “X employs A or B” is intended to mean one of natural inclusive substitutions, which is “X uses A or B”. That is, when X uses A; or X uses B; or X uses both A and B, “X uses A or B” may be applied to either of the cases. In addition, a term “and/or” as used herein should be understood to refer to and include all possible combinations of one or more of listed related items.

In addition, terms “comprise” and/or “include” should be understood to mean that there are corresponding characteristics and/or components. However, it should be understood that the terms “comprise” and/or “include” do not exclude presence or addition of one or more other characteristics, components, and/or groups thereof. In addition, unless otherwise specified or when the context is not clear to indicate a singular form, the singular form in the specification and claims should be interpreted as meaning “one or more” in general.

In addition, “more than” and/or “less than” may be interpreted as “exceeding” and/or “below”, and vice versa.

Those skilled in the art should recognize that various illustrative logical blocks, configurations, modules, circuits, means, logics, and algorithm steps described in connection with the embodiments disclosed herein may be implemented by electronic hardware, computer software, or a combination of thereof. In order to clearly describe interchangeability of hardware and software, various illustrative components, blocks, configurations, means, logics, modules, circuits, and steps are described above in general in terms of their functionality. Whether or not the functionality is implemented by hardware or as software depends on a specific application and design limitations imposed on the overall system. Skilled technicians may implement the functionality described in various ways for each particular application. However, determination of the implementation should not be interpreted as causing a departure from the scope of the present disclosure.

Descriptions of the presented embodiments are provided such that those skilled in the art of the present disclosure may use or implement the present disclosure. Various modifications of the embodiments will be apparent to those skilled in the art. General principles defined herein may be applied to other embodiments without departing from the scope of the present disclosure. Thus, the present disclosure is not limited to the embodiments presented herein. The present disclosure should be interpreted the widest scope consistent with the principles and novel characteristics presented herein.

In the embodiments of the present disclosure, a layer may mean a layer that is displayed on a user interface and used to overlap and display multiple images. Two or more layers may also overlap each other to be displayed. When two or more layers overlap each other to be displayed, one layer may hide the other layer and may not be visible. Alternatively, two or more layers overlap each other, and when an upper layer is partially semi-transparent, at least a part of a lower layer may be visible. The two or more layers may have the same size. In addition, the two or more layers may also have different sizes from each other. The layer may include one or more regions. In addition, the layer may include one or more display objects.

In the embodiments of the present disclosure, a layer may be divided into a plurality of regions. The plurality of regions may be spaces on a screen that do not overlap each other. One layer may include only one region or a plurality of regions. One region may include one or more display objects.

In the embodiments of the present disclosure, an object may be a set of pictures, symbols, or letters respectively corresponding to a program, commands, or data. According to an embodiment of the present disclosure, the object may be used to receive a user's selective input. For example, when receiving a user input for the object, the processor 120 may execute commands or data stored in correspondence with the related object and display the commands or data on a user interface. In the embodiments of the present disclosure, an object and a display object may be interpreted as having the same meaning.

In the embodiments of the present disclosure, “displaying” may indicate an operation of displaying data to a user through an output unit 140. “Display” and “displaying” may be used interchangeably.

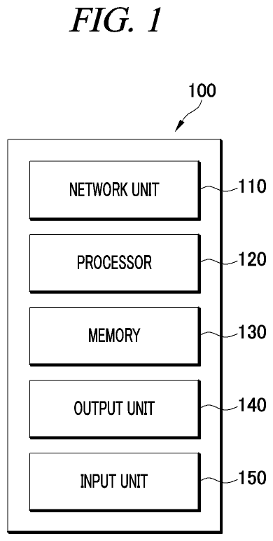

FIG. 1 is a block diagram of a computing device that performs an operation of providing a method of displaying data according to an embodiment of the present disclosure. A configuration of a computing device 100 illustrated in FIG. 1 is only an example simply illustrated. In the embodiment of the present disclosure, the computing device 100 may include other components for performing a computing environment of the computing device 100, and only some of the disclosed components may also configure the computing device 100.

The computing device 100 for providing the method of displaying data according to the embodiment of the present disclosure may include a network unit 110, a processor 120, a memory 130, an output unit 140, and an input unit 150.

Hereinafter, a user interface that provides the method of displaying data will be described.

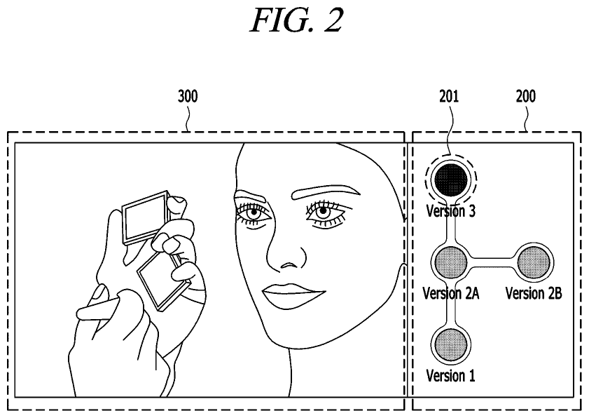

The user interface may display a version tree layer and a data display layer. Hereinafter, a version tree layer 200 and a data display layer 300 will be described with reference to FIG. 2. The data display layer 300 may display corresponding data according to a selective input for at least one of versions or subversions included in the version tree layer 200.

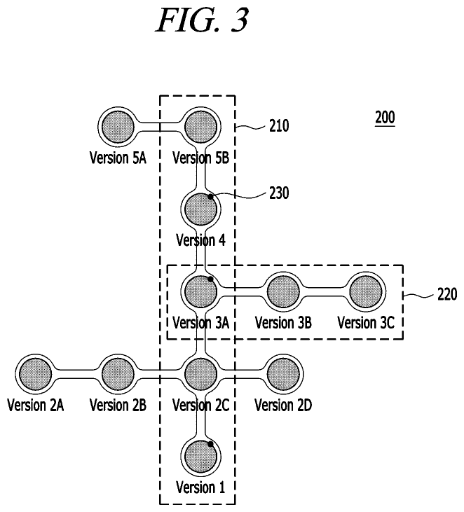

Hereinafter, a version tree will be described with reference to FIG. 3.

The version tree layer 200 may display a version tree. The version tree may be a structure in which each version is formed in the form of a node and a relationship between the versions is illustrated in the form of a tree. The version tree may include a main tree 210 and a subtree 220. The version tree may include one main tree 210 and one or more subtrees 220.

The main tree 210 may be composed of one or more versions. The main tree 210 may be a tree indicating a process of updating a workpiece for a work of the same purpose. The main tree 210 illustrated in FIG. 3 may include a version 1, a version 2C, a version 3A, a version 4, and a version 5B. Two or more versions included in the main tree 210 may have a precedence relationship. A second version included in the main tree 210 may be a version generated after a first version. The second version may be a version generated based on the first version. The second version may be an updated version of the first version. The detailed description of the above-described main tree is merely an example, and the present disclosure is not limited thereto.

The subtree 220 may be composed of one or more subversions. Two or more subversions included in the subtree 220 may have a parallel relationship. Two or more subversions included in the same subtree 220 may not have a precedence relationship. Two or more subversions included in the same subtree 220 may be versions updated based on the same version. Two or more subversions included in the same subtree 220 may be versions updated in different ways based on the same version. For example, the first subtree may include a version 2A, a version 2B, the version 2C, and a version 2D, and the second subtree may include the version 3A, a version 3B, and a version 3C. The version 3A, the version 3B, and the version 3C, which are subversions included in the second subtree, may be versions updated based on the version 2C included in the first subtree, respectively. That is, the subversions included in the same subtree (second subtree) may be versions updated in different ways based on one subversion (subversion of the first subtree). For example, an illustration corresponding to the version 2C may be updated to a color of a first series to generate the version 3A and may be updated to a color of a second series to generate the version 3B and may be updated to a color of a third series to generate the version 3C. The detailed description of the above-described subtree is merely an example, and the present disclosure is not limited thereto.

The version included in the main tree 210 may be a subversion selected from one or more subversions included in the subtree 220. The subtree 220 may include two or more subversions, and each of the two or more subversions may be a version updated from the same version in a different manner. The processor 120 may receive a user's selective input for at least one subversion among two or more subversions. The processor 120 may determine one subversion selectively inputted by the user as a version to be included in the main tree 210. In the above example, the user may finally select the version 3A updated to a color of a first series from among the updated versions 3A to 3C to correspond to each of the plurality of series and may not select the version 3B and the version 3C. The processor 120 may form the main tree 210 to include the version 3A. That is, the subversion included in the main tree 210 may be a version selected by the user. The subversions not included in the main tree 210 may be versions not selected by the user. For example, only the version 3A selected by a client from among the versions 3A to 3C generated by a company may be included in the main tree 210. Workpieces updated based on the version 3A selected by the client may be subsequently generated. The detailed description of the above-described version tree is merely an example, and the present disclosure is not limited thereto.

The version tree illustrated in FIG. 3 illustrates one main tree and two or more subtrees, but the version tree according to an embodiment of the present disclosure may include two or more main trees. That is, when intending to generate a plurality of workpieces, a user may generate two or more main trees. When two or more workpieces are to be finally generated based on one workpiece, the main tree may be two or more. For example, when a user intends to generate an advertisement for bus and another advertisement for subway based on one advertisement workpiece, a first main tree may be a workpiece related to the advertisement for bus, and a second main tree may also be a workpiece related to the advertisement for subway. In addition, two or more main trees may also be trees derived based on one main tree. The detailed description of the above-described version tree is merely an example, and the present disclosure is not limited thereto.

The data display layer 300 may display data corresponding to a subversion selected and inputted by a user in response to a selective input for at least one subversion included in the version tree.

The data display layer 300 may display data. The data may mean any type of files that may be transmitted. For example, the data may be image files such as png, jpg, and ai, document files such as word, Korean, pdf, ppt, and excel, codes written in java, video files such as TS, mp4, avi, and mov, and so on, but the present disclosure is not limited thereto.

The data display layer 300 may display data corresponding to the selectively inputted subversion. The processor 120 may receive a user's selection input for at least one version among a plurality of subversions included in the version tree. The processor 120 may distinguish the subversion 201 from other subversions that are selectively inputted, and display the subversions. The processor 120 may display a visual representation for the selectively inputted subversion 201 so as to be distinguished from other subversions. The visual representation of the selectively inputted subversion 201 may include a node contrast, a color, and so on of the corresponding version or may include an icon such as a check display. The detailed description of the above-described selection of the subversion is only an example, and the present disclosure is not limited thereto.

The processor 120 may identify the selectively inputted subversion and display data corresponding to the selectively inputted subversion on the data display layer 300. When there are two or more selectively inputted subversions, the processor 120 may display data corresponding to each of the two or more subversions on the data display layer 300. When displaying the data corresponding to two or more subversions, the processor 120 may divide the data display layer 300 into two or more regions to display the data in each region. Alternatively, when displaying the data corresponding to the two or more subversions, the processor 120 may overlap the two or more data to be displayed on the data display layer 300. Alternatively, the processor 120 may compare two or more data with each other to be displayed. A method of comparing two or more data with each other to be displayed will be described below. The detailed description of the above-described data display is only an example, and the present disclosure is not limited thereto.

The method of displaying data on the data display layer 300 may be adjusted. The data displayed on the data display layer 300 may be, for example, enlarged or reduced, and the data may be moved such that another part thereof is located at the center of the layer. Alternatively, the data (for example, document, image, and so on) displayed on the data display layer 300 may be adjusted such that a lower or upper portion of the data may also be checked based on a user input (for example, scroll and so on). The detailed description of the above-described data display is only an example, and the present disclosure is not limited thereto.

The data displayed on the data display layer 300 may have an editable form. The processor 120 may receive a user input for editing the data displayed on the data display layer 300. That is, data may be edited on the data display layer 300. For example, a part of data including a document, an image, or a video may also be directly edited on the data display layer 300. The processor 120 may newly store the edited data on the data display layer 300 as a separate version. The processor 120 may also update a version tree to include a subversion corresponding to the data edited on the data display layer 300. The detailed description of the above-described data display layer is merely an example, and the present disclosure is not limited thereto.

The version tree layer 200 and the data display layer 300 may be arranged side by side. Although the version tree layer 200 and the data display layer 300 are illustrated to be arranged side by side in FIG. 2, the present disclosure is not limited thereto. The version tree layer 200 and the data display layer 300 may also be arranged vertically and side by side. Alternatively, the version tree layer 200 may be changed in size or position. The size of the version tree layer 200 may be expanded or reduced according to a user input, and correspondingly, the size of the data display layer 300 may also be reduced or expanded. The version tree layer 200 may also be arranged on the right side of the data display layer 300 and may be arranged above or below the data display layer 300 by being adjusted according to a user input. The detailed description of the arrangement of the above-described layer is merely an example, and the present disclosure is not limited thereto.

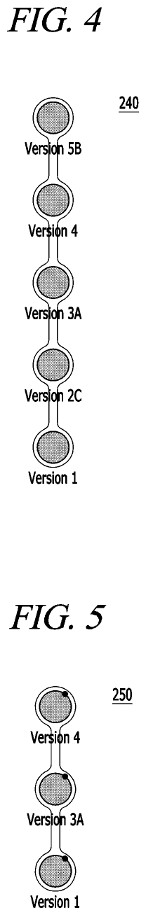

Hereinafter, a method of simplifying the version tree will be described with reference to FIG. 4.

The version tree layer 200 may display the simplified version tree 240 in response to a simple view input for simplifying the version tree. The simplified version tree 240 may be a version tree displayed by omitting at least some of the versions of the tree. The simplified version tree 240 may display only versions corresponding to the main tree.

When only one main tree is displayed in the version tree, the simplified version tree 240 may include only one main tree. The simplified version tree 240 may include only one subversion among a plurality of subversions included in one subtree, which was included in the version tree. For example, among the subversions illustrated in FIG. 3, a simplified version tree 240 including only subversions (version 1, version 2C, version 3A, version 4, and version 5) selectively inputted by a user may be displayed. When two or more main trees are displayed in the version tree, two or more main trees may be included in the simplified version tree 240 as well. The detailed description of the above-described simplified version tree is only an example, and the present disclosure is not limited thereto.

A user may check only the version selected from among the plurality of subversions at a glance through the simplified version tree 240. That is, the user may collect and check only subversions that are the basis of the final result through the simplified version tree 240.

The processor 120 may display the version tree by expanding the simplified version tree 240 in response to a full view input. That is, when the user clicks the full view in contrast to this, the version tree including all subversions is changed from the simplified version tree to be displayed on a user interface.

The version tree layer 200 may be displayed in a reduced region while the simplified version tree 240 is displayed. Correspondingly, a region of the data display layer 300 may be expanded to be displayed.

Hereinafter, a major update of a version will be described with reference to FIG. 5.

The version tree layer 200 may include visual highlighting to at least some versions of one or more versions included in the version tree. The Visual highlighting of the version tree layer 200 may also be generated based on a degree of update to the versions. When compared with data of a previous version, the version tree layer 200 may display a major update 230 on a version of data having a change of more than a threshold. The version displayed with the major update may be determined to be updated a lot when compared with the previous version. It may be determined that the version without the major update is not updated a lot when compared with the previous version. Although FIG. 5 illustrate that the major update 230 is displayed, this is only an example, and both major update and minor update may also be displayed, or only minor update may also be displayed.

Hereinafter, a method of determining a major update will be described.

The processor 120 may compare data corresponding to two or more versions. The processor 120 may determine a version of data having a change of more than a threshold as a major update version. The processor 120 may determine a version of the data having a change of less than the threshold as a minor update version.

For example, the processor 120 may calculate a character match degree of data corresponding to two or more versions. For example, the processor 120 may calculate whether or not characters included in each piece of data (for example, a document, an image, or a video) match each other, or whether or not characters included in the same position of each piece of data match each other. When a ratio of the matching characters included in each piece of data is greater than or equal to a threshold ratio among all characters, the processor 120 may determine that there is no change greater than or equal to a threshold. When the ratio of the matching characters included in each piece of data is less than the threshold ratio among all characters, the processor 120 may determine that there is a change greater than or equal to the threshold. The detailed description of the above-described major update is only an example, and the present disclosure is not limited thereto. In addition, the detailed description of the above-described data is only an example and may include various types of data that users may check.

For example, the processor 120 may calculate a degree of a change in color of data corresponding to two or more versions. The processor 120 may calculate a histogram distribution of colors included in the data. The processor 120 may calculate a histogram distribution for respective colors of pixels included in the data. The processor 120 may calculate a similarity of a histogram distribution of each of two or more pieces of data. When two or more histogram distributions are similar to each other, the processor 120 may determine that there is no change of greater than or equal to a threshold. When the two or more histogram distributions are not similar to each other, the processor 120 may determine that there is a change of greater than or equal to a threshold. The processor 120 may calculate values such as correlation, Chi-square, intersection, and Bhattacharyya for two or more histograms. For example, the smaller the correlation or intersection value, or for example, the greater the Chi-square or Bhattacharyya value, the processor 120 may determine that the data are not similar to each other, thereby determining as a major update. The detailed description of the above-described major update is only an example, and the present disclosure is not limited thereto.

For example, the processor 120 may also calculate a degree of a change in each version by analyzing each version by using a deep learning algorithm for two or more versions. For example, the processor 120 may calculate a degree of change in features corresponding to two or more versions. The processor 120 may extract features by using, for example, previously learned neural network functions. The previously learned neural network functions include, for example, a convolutional neural network (CNN), a multi-layer perceptron (MLP), a recurrent neural network (RNN), a restricted Boltzmann machine (RBM), a deep belief network (DBN), a Q network, a U network, a Siam network, and so on, but the present disclosure is not limited thereto. The processor 120 may extract features by using, for example, canny edge detection, harris corner detection, or so on. The processor 120 may extract features by blurring data (for example, images, videos, and so on) through the canny edge detection to remove noise, by detecting an edge using a mask edge, by removing a non-maximum value, and by dividing a size to a double threshold to connecting edges. The processor 120 may determine the major update according to a degree of matching of the features extracted from each piece of data. The detailed description of the above-described major update is only an example, and the present disclosure is not limited thereto.

According to an embodiment of the present disclosure, the processor 120 may output changed portions of two or more pieces of data by using a previously learned algorithm (for example, open CV, vision AI, or so on). For example, the processor 120 may output a result of displaying the changed portion by using the previously learned algorithm. As for the output result, a portion having many changes (for example, object change) may be displayed in white, a portion having a partial change (for example, color change) may be displayed in grayscale, and a portion having no change may be displayed in black. In addition, a brightness of the grayscale may be displayed differently depending on the degree of changes. When the outputted result includes white or grayscale greater than or equal to a threshold, the processor 120 may determine that there are many changes in data by using the previously learned algorithm, thereby determining as a major update. The detailed description of the above-described major update is only an example, and the present disclosure is not limited thereto.

The version tree layer 200 may display a major update version tree 250 in response to a major update view input for viewing simplified versions corresponding to the major update. The major update version tree 250 may display only versions corresponding to the major update. The major update version tree 250 may display only versions corresponding to the major update except for versions or subversions not corresponding to the major update. For example, the processor 120 may calculate whether or not there are many changes in the version 1, the version 2C, the version 3A, the version 4, and the version 5B, which are included in the main tree 210 of FIG. 3 as compared with the previous version. The processor 120 may determine the version 1, the version 3A, and the version 4 among the versions of the main tree 210, as a major update. The previous version of version 1 does not exist, but since new data is formed for the version 1, the version 1 may be determined as a major update. The processor 120 may display the major update version tree 250 including only the version 1, the version 3A, and the version 4 in response to a major update view input. The detailed description of the above-described major update is only an example, and the present disclosure is not limited thereto.

While data is continuously updated, there may be versions updated a lot and versions updated a little. By collecting and checking only the versions updated a lot, a user may efficiently check which update process is performed to update data. That is, the user may efficiently check the update by not separately checking minor changes.

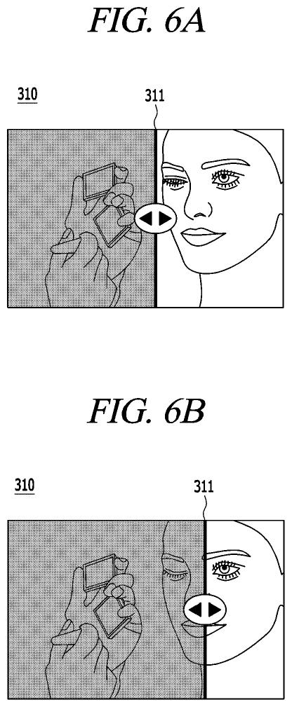

Hereinafter, a method of comparing two or more pieces of data will be described with reference to FIG. 6.

A user interface may display a data comparison layer 310. The processor 120 may receive a selective input for two or more versions included in the version tree. The processor 120 may receive a comparative input for comparing data corresponding to each of the selected two or more versions. The processor 120 may compare two or more pieces of data corresponding to each of two or more versions and display the comparison results on the data comparison layer 310.

The data comparison layer 310 may overlap first data corresponding to a first version and second data corresponding to a second version to display. For example, when the first data and the second data are images, the processor 120 may overlap the first data and the second data to display by matching sizes or central portions of the data. For example, the processor 120 may display data to be overlapped with each other based on a portion of each of the first data and the second data. The detailed description of the above-described data is merely an example, and the present disclosure is not limited thereto.

The data comparison layer 310 may display the first data on an upper portion in one region based on an axis 311 such that the second data is not displayed, and may display the second data on an upper portion in another region based on the axis 311 such that the first data is not displayed. In response to a movement input for moving the axis 311, the data comparison layer 310 may expand a size of the one region where the first data is played on the upper side to display the one region and may reduce a size of another region where the second data is played on the upper side to display another region. That is, by moving the axis 311 to check data, a user may easily check which part of the data is changed. When the axis 311 moves over a portion where the second data is not changed based on the first data, there may be no portion to be displayed differently on the data comparison layer 310 according to movement of the axis 311. On the other hand, when the axis 311 moves over the portion where the second data is changed based on the first data, the changed portion may be displayed differently on the data comparison layer 310 according to the movement of the axis 311. That is, when there is a portion that changes while the axis 311 moves, the user may check that there is an update in the corresponding portion. The detailed description of the above-described data comparison layer is only an example, and the present disclosure is not limited thereto.

The first data may be displayed on the left of the axis 311 of the data comparison layer 310 of A of FIG. 6, and the second data may be displayed on the right of the axis 311. The first data and the second data may overlap each other to be displayed. B of FIG. 6 illustrates the data comparison layer 310 having the axis 311 moved to the right. While moving the axis 311 to the right, a user may check that a left eye portion of A of FIG. 6 and the left eye portion of B of FIG. 6 are changed. Although the axes 311 of FIG. 6 are illustrated to move in the left and right directions, the present disclosure is not limited thereto and may include all moving in various directions, such as an up-down direction and a diagonal direction. The detailed description of the above-described data comparison layer is only an example, and the present disclosure is not limited thereto.

When a user places data in parallel and checks a changed portion, it may be difficult for the user to check at a glance which portion is changed. In particular, when the data is complex or a size of the changed portion is small (that is, minor update), it may be more difficult for the user to check the updated portion in the data displayed side by side in parallel. When checking the changed portion through movement of an axis of the data comparison layer according to the embodiment of the present disclosure, a user may easily check complex data or minor update.

The data comparison layer 310 may adjust and display a visualization method for at least one of the first data corresponding to a first version or the second data corresponding to a second version in response to an adjustment input regarding a visualization adjustment object.

The visualization adjustment object may be a graphic object for adjusting a method of displaying data.

The visualization adjustment object according to an embodiment of the present disclosure may be a display object displayed on the data comparison layer 310. For example, the visualization adjustment object may be an object for a user to input a degree of visualization adjustment as a number. Alternatively, the visualization adjustment object may be an object for a user to input a degree of visualization adjustment by selecting a value within a predetermined range (for example, 0 to 100). Alternatively, the visualization adjustment object may be an object for inputting a degree of visualization adjustment by selecting one of previously determined values (for example, +50, 0, −50). The detailed description of the above-described visualization adjustment object is only an example, and the present disclosure is not limited thereto.

The visualization adjustment object according to an embodiment of the present disclosure may be a display object that is displayed by being overlapped with the axis 311. For example, a circular display object overlapping the axis 311 illustrated in FIG. 6 may be the visualization adjustment object. For example, when the circular display object is moved left or right, sizes of display regions of the first data and the second data may be changed. In addition, when the circular display object is moved up and down, a degree of visualization of the first data and the second data may be adjusted to be displayed. The detailed description of the above-described visualization adjustment object is only an example, and the present disclosure is not limited thereto.

The processor 120 may adjust a visualization method for the first data. Alternatively, the processor 120 may adjust the visualization method for the second data. Alternatively, the processor 120 may adjust a visualization method for the first data and the second data.

The processor 120 may receive a user's selective input for at least one of the first data and the second data. The processor 120 may adjust a visualization method for the data selectively inputted by a user. That is, the user may click the region where the data for which the user intends to adjust the visualization method is displayed, such that the visualization method of the corresponding data portion is adjusted.

Adjustment of the method of displaying data may be, for example, adjustment of data transparency. For example, the processor 120 may adjust transparency based on an adjustment input for a visualization adjustment object. In the above-described example, the processor 120 may display a higher transparency as the circular display object illustrated in FIG. 6 is raised and may display a lower transparency as the circular display object is lowered. When the transparency of the first data is displayed high, the first data and the second data may be partially overlapped with each other to be displayed to a user. Since the transparency of the first data is displayed high, the user may quickly check a different part between the first data and the second data. The detailed description of the above-described data display method adjustment is only an example, and the present disclosure is not limited thereto.

The adjustment of the method of displaying data may be adjustment of, for example, data color inversion, lightness, saturation, and brightness of the data. For example, when the user compares the first data of the first version with the second data of the second version after the first version, the first data is displayed in grayscale to emphasize that the first data is a previous version, and the second data may be displayed in a basic color tone. The processor 120 may display a higher or lower grayscale of the first data according to the degree of adjustment of the visualization adjustment object. The detailed description of the above-described adjustment of the method of displaying data is only an example, and the present disclosure is not limited thereto.

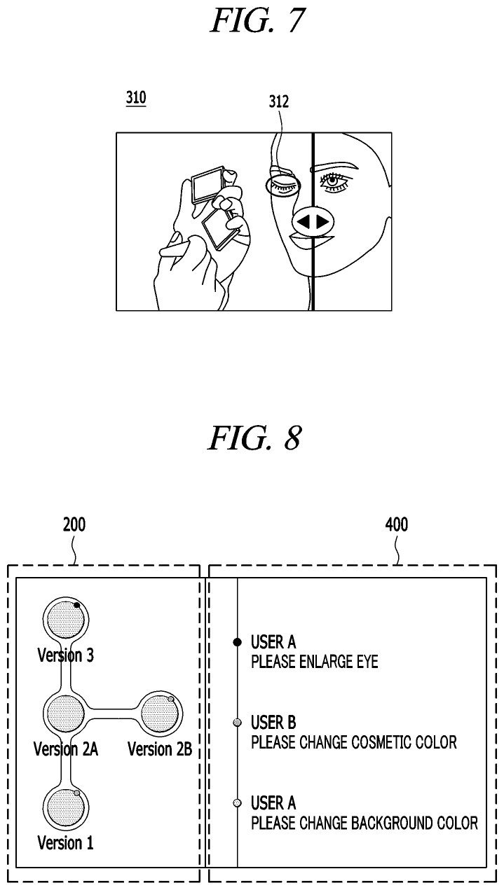

Hereinafter, a method of displaying annotation according to data comparison will be described with reference to FIG. 7.

The data comparison layer 310 may display an annotation 312 on a portion changed between data. The data comparison layer 310 may display the annotation 312 on a portion changed from the second data based on the first data.

The annotation 312 may be a visual representation different from data. Although FIG. 7 is illustrated to display a circular annotation 312, the annotation 312 may be displayed in other ways. For example, the annotation 312 may include whether or not a corresponding location is changed, content of the change, and so on. For example, the processor 120 may display different annotations for a portion that is changed a lot and a portion that is changed a little. The processor 120 may also generate an annotation display of a dark color for a portion (for example, an object change) that is changed a lot, and may also generate an annotation display of a light color for a portion (for example, a color change for the same object) that is changed a little. The detailed description of the above-described annotation display is only an example, and the present disclosure is not limited thereto.

The data comparison layer 310 may display the annotation 312 on at least one of the first data and the second data. For example, the processor 120 may display an annotation only in a first data region or a second data region in relation to a changed portion or may display the annotation in both the first data region and the second data region. The detailed description of the above-described annotation display is only an example, and the present disclosure is not limited thereto.

In response to a change confirmation input for an annotation, the processor 120 may generate data of a new version to which a change in a portion corresponding to the change confirmation input among one or more annotations. Two or more annotations may be displayed on the data comparison layer 310. The processor 120 may receive a change confirmation input for at least some of the two or more annotations displayed on the data comparison layer 310. The processor 120 may apply the changed content of the portion corresponding to the annotation that is changed and inputted and may not apply the changed content of the portion corresponding to the other annotation. The processor 120 may store, in the memory 130, data obtained by applying the changed content corresponding to the change confirmation input as a new version. The processor 120 may store the new version generated based on the change confirmation input as a next version of the first data or the second data. The detailed description of the above-described annotation change confirmation input is only an example, and the present disclosure is not limited thereto.

Hereinafter, a method of generating a version tree will be described.

According to an embodiment of the present disclosure, the version tree layer 200 may update and display a version tree to include new data in a position corresponding to a version input based on the new data and the version input for the new data. The processor 120 may receive an input for uploading new data. The processor 120 may receive the version input for the new data. The version input may display version identification information for the new data. For example, the version input may be a number, a letter, or so on to identify the version. A user may input version identification information of data while uploading the new data to the software. The processor 120 may newly form a node of a corresponding version at a location corresponding to the version identification information. For example, when the “version 3B” is inputted while uploading a data file, the processor 120 may form a version 3B node in parallel with a version 3A node. Alternatively, when the “version 4” is inputted while uploading the data file, the processor 120 may generate a node having a vertical relationship with the version 3A to the version 3C. Detailed description of the above-described version tree is merely an example, and the present disclosure is not limited thereto.

When receiving a new version input, the processor 120 may determine a subversion having the highest similarity to the new version among the subversions corresponding to the previous version as a version included in the main tree and may include the new version in the main tree. For example, when a user inputs the “version 4” while uploading a data file, it is possible to identify a subversion having the highest similarity among a version 4 data file, a subversion 3A data file, and a subversion 3C data file. The processor 120 may determine that the version 4 data file and the subversion 3B data file have the highest similarity. The processor 120 may determine the subversion 3B among the subversion 3A to the subversion 3C as a version to be included in the main tree. The processor 120 may generate the main tree by connecting the subversion 3B to the version 4. The detailed description of the above-described version tree is merely an example, and the present disclosure is not limited thereto.

According to the embodiment of the present disclosure, the version tree layer 200 may update and display a version tree such that a subversion of new data is included in a position corresponding to the connection input, in response to a connection input connecting new data to at least one of a version or subversion included in the version tree. The processor 120 may receive an input for uploading the new data. The connection input may be an input for connecting a node corresponding to the new data to a node included in the existing version tree. For example, by distinguishing a click on a node of the new data from a click on a node included in the existing version tree, the processor 120 may connect each node to update the version tree. For example, when a user horizontally places a node corresponding to the new data together with the existing node and generates a horizontal connection input for the existing node and the new node, the processor 120 may determine that the new data corresponds to a subversion of the existing version other than the new version. Alternatively, when the node is placed in a vertical direction, the processor may determine that the new data corresponds to a next version obtained by updating the existing version other than a subversion of the existing version. Detailed description of the above-described version tree is merely an example, and the present disclosure is not limited thereto.

The processor 120 may determine a version of the new data based on a node corresponding to the new data and an arrangement of nodes included in the existing version tree. For example, when the node corresponding to the new data is arranged vertically with the node included in the existing version tree, the processor 120 may determine that the new data has a new version. When the node corresponding to the new data is arranged in parallel with the node included in the existing version tree, the processor 120 may determine that the new data has another subversion included in the existing version. When the node corresponding to the new data is located near an upper portion of the node included in the existing version tree, the processor 120 may determine that the new data has a next version of the node in the existing version tree. When the node corresponding to the new data is located near the right or the left of the node included in the existing version tree, the processor 120 may determine that the new data has another subversion different from the subversion included in the same version of the existing version tree. The detailed description of the above-described version tree is merely an example, and the present disclosure is not limited thereto.

Hereinafter, a comment display for data will be described with reference to FIG. 8.

The version tree layer 200 may display a comment object on at least some versions of one or more versions. Users may display comment on data. The processor 120 may match a comment inputted by a user and data and store the data. When there is a comment matched with the data, the processor 120 may display a comment object on a corresponding node of a version tree. Although FIG. 8 illustrates that comment objects are displayed on the nodes of the version tree as small circles, but this is only an example and may include various other visual representations.

A user interface may display the comment display layer 400. The comment display layer 400 may display comments included in the version tree in response to a comment view input for viewing the comments. That is, the comment display layer may collect and display comments corresponding to a plurality of versions at once. The processor 120 may display the comments in chronological order. The processor 120 may display a visual expression corresponding to a comment object displayed in the version tree on the comment of the comment display layer 400. For example, a comment object may be displayed in red in version 1, and a red object may be displayed in the comment of the comment display layer 400. The detailed description of the above-described comments is for illustrative purposes only, and the present disclosure is not limited thereto.

When using the method of displaying data according to the embodiment of the present disclosure, a work convenience for a user may be increased. The user may generate multiple versions of a workpiece and often update the versions. According to the present method, a user may effectively manage data corresponding to a plurality of versions. In addition, data corresponding to the plurality of versions may be effectively compared with each other.

The network unit 110 may transmit and receive data and so on to and from a computing device, a server, or so on to provide the method of displaying data according to the embodiment of the present disclosure. The network unit 110 may transmit and receive data, such as a version and a comment, necessary for the embodiment of the present disclosure to and from the computing device, the server, and so on. For example, the network unit 110 may receive data, comments, and so on corresponding to versions from a database and so on.

The network unit 110 according to the embodiment of the present disclosure may use various wired or wireless communication systems without limitation. In the present disclosure, the network unit 110 may be configured with various communication types such as a wired type and a wireless type.

The processor 120 may be configured by one or more cores and may include a processor for displaying data, such as a central processing unit (CPU), a general-purpose graphics processing unit (GPGPU), or a tensor processing unit (TPU) of a computing device. The processor 120 may provide a data display interface according to the embodiment of the present disclosure by reading a computer program stored in the memory 130. In addition, a computer program executed by the computing device according to the embodiment of the present disclosure may be a program that may be executed by the CPU, the GPGPU, or the TPU.

According to the embodiment of the present disclosure, the memory 130 may store information of any type generated or determined by the processor 120 and information of any type received by the network unit 110.

According to the embodiment of the present disclosure, the memory 130 may include at least one of storage media such as flash memory, a hard disk, a multimedia card micro type, card type memory (for example, secure digital (SD) memory or extreme digital (XD) memory), random access memory (RAM), static random access memory (SRAM), read-only memory (ROM), electrically erasable programmable read-only memory (EEPROM), programmable read-only memory (PROM), magnetic memory, a magnetic disk, and an optical disk. The computing device 100 may also operate in connection with a web storage that performs a storage function of the memory 130 on the Internet. The description of the above-described memory is only an example, and the present disclosure is not limited thereto.

The output unit 140 according to an embodiment of the present disclosure may display a version tree and a certain user interface (UI) for displaying data. The output unit 140 may display the user interface illustrated in FIGS. 2 to 8. User interfaces to be illustrated and described below are only examples, and the present disclosure is not limited thereto.

The output unit 140 according to the embodiment of the present disclosure may output information of any type generated or determined by the processor 120 and information of any type received by the network unit 110.

In one embodiment of the present disclosure, the output unit 140 may include at least one of a liquid crystal display (LCD), a thin film transistor liquid crystal display (TFT LCD), an organic light-emitting diode (OLED), a flexible display, and a three-dimensional (3D) display. Some of the display modules may be formed to be transparent or light-transmissive such that the outside may be seen therethrough. This may be referred to as a transparent display module, and a representative example of the transparent display module is a transparent OLED (TOLED).

The input unit 150 according to the embodiment of the present disclosure may receive a user input. The input unit 150 according to the embodiment of the present disclosure may include keys and/or buttons for receiving the user input. A computer program for providing the method of displaying data according to the embodiment of the present disclosure may be executed according to the user input of the input unit 150.

The input unit 150 according to the embodiment of the present disclosure may receive a signal by detecting a button operation or a touch input performed by a user or may receive voice or motion of the user through a camera or a microphone to convert the signal, the voice, or the motion into an input signal. To this end, a speech recognition technology or a motion recognition technology may be used therefor.

The input unit 150 according to the embodiment of the present disclosure may also be configured by an external input device connected to the computing device 100. For example, the input device may be at least one of a touch pad, a touch pen, a keyboard, and a mouse for receiving a user input, but this is only an example and the present disclosure is not limited thereto.

The input unit 150 according to the embodiment of the present disclosure may recognize a touch input of a user. The input unit 150 according to the embodiment of the present disclosure may have the same configuration as the output unit 140. The input unit 150 may be configured by a touch screen for receiving a selective input of the user. For the touch screen, any one of a contact type capacitance method, an infrared light sensing method, a surface ultrasonic wave (SAW) method, a piezoelectric method, and a resistive film method may be used. Detailed description of the above-described touch screen is only an example according to the embodiment of the present disclosure, and various touch screen panels may be employed in the computing device 100. The input unit 150 configured as a touch screen may include a touch sensor. The touch sensor may convert a change in pressure applied to a specific portion of the input unit 150, a change in capacitance generated at a specific portion of the input unit 150, or so on into an electrical input signal. The touch sensor may detect not only touched position and area, but also a pressure at the time of touching. When there is a touch input to the touch sensor, a signal corresponding thereto is transmitted to a touch controller. The touch controller processes the signal and then transmits data corresponding thereto to the processor 120. As a result, the processor 120 may recognize whether or not any region of the input unit 150 is touched, and so on.

In one embodiment of the present disclosure, a server may also include other components for measuring an environment of the server. The server may include any type of device. The server may include a digital device and may be a digital device, which includes a processor and a memory device capable of performing a calculation, such as a laptop computer, a notebook computer, a desktop computer, a web pad, and a mobile phone.

A server (not illustrated) that performs an operation of providing a user interface for displaying data and the version tree according to the embodiment of the present disclosure to a user terminal may include a network unit, a processor, and a memory.

The server may generate the user interface according to the embodiment of the present disclosure. The server may be a computing system that provides information to a client (for example, a user terminal) through a network. The server may transmit the generated user interface to the user terminal. In this case, the user terminal may be any type of computing device 100 capable of accessing the server. A processor of the server may transmit the user interface to the user terminal through a network unit. The server according to the embodiment of the present disclosure may be, for example, a cloud server. The server may be a web server that processes services. The servers described above are only examples, and the present disclosure is not limited thereto.

Each of the network unit, the processor, and the memory included in the server according to the embodiment of the present disclosure may perform the same function as or may have the same configuration as the network unit 110, the processor 120, and the memory 130 included in the above-described computing device 100.

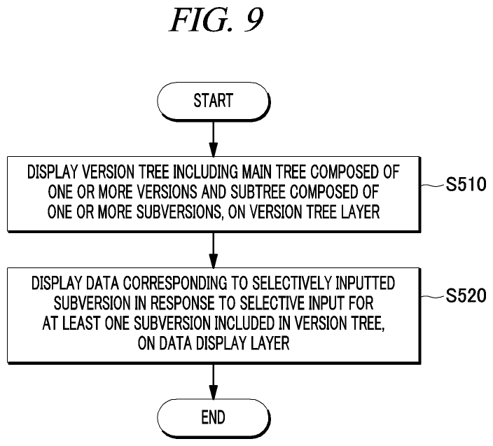

FIG. 9 is a flowchart for providing a method of display data according to the embodiment of the present disclosure.

The computing device 100 may perform a step 510 of displaying a version tree that includes a main tree composed of one or more versions and a subtree composed of one or more subversions, on a version tree layer. Two or more versions included in the main tree may have a precedence relationship. Two or more subversions included in the subtree may have a parallel relationship. The version included in the main tree may be a subversion selected from one or more subversions included in the subtree. The computing device 100 may display a major update on a version of data having a change greater than a threshold on the version tree layer when compared with data of a previous version.

The computing device 100 may a step 520 of displaying data corresponding to the selectively inputted subversion in response to a selective input for at least one subversion included in the version tree, on the data display layer.

The computing device 100 may display only versions corresponding to the main tree in response to a simple view input for viewing a simplified version tree, on the version tree layer.

The computing device 100 may display only versions corresponding to the major update except for versions not corresponding to the major update, in response to a major update view input for viewing a simplified version corresponding to the major update.

The computing device 100 may compare two or more pieces of data corresponding to two or more versions, respectively, in response to a comparison input for the two or more versions included in the version tree to compare the two or more pieces of data and displays the compared results on the data comparison layer. The computing device 100 may overlap first data corresponding to a first version with second data corresponding to a second version and display the overlapped data on the data comparison layer, and may display the first data on an upper side in one region based on an axis such that the second data is not displayed and display the second data on an upper side in another region based on the axis such that the first data is not displayed, and may expand a size of the one region where the first data is displayed on the upper side and reduce a size of another region where the second data is displayed on the upper side, in response to a movement input for moving the axis. The computing device 100 may adjust a visualization method for at least one of the first data corresponding to the first version or the second data corresponding to the second version in response to an adjustment input for a visualization adjustment object and may display the data on the data comparison layer. The computing device 100 may adjust the visualization method for at least one of the first data and the second data in response to an adjustment input in a direction different from a movement input in relation to the visualization adjustment object displayed on the axis and may display the data on the data comparison layer. The computing device 100 may generate data of a new version by applying a change in portion corresponding to a change confirmation input among one or more annotations in response to the change confirmation input to the annotations.

The computing device 100 may update the version tree such that new data is included in a position corresponding to a version input based on new data and the version input for the new data and display on the version tree layer.

the computing device 100 may update a version tree such that a subversion of the new data is included in a position corresponding to a connection input in response to a connection input for connecting the version tree layer to at least one of the new data to and a version or subversion included in the version tree and display the updated version tree on the version tree layer.

The computing device 100 may display a comment object on at least some versions of one or more versions on the version tree layer. The computing device 100 may display comments included in the version tree in response to a comment view input for viewing comments on the comment display layer.

The method of displaying data according to the present disclosure may be performed by logics, modules, circuits, or means for performing the method of displaying data.

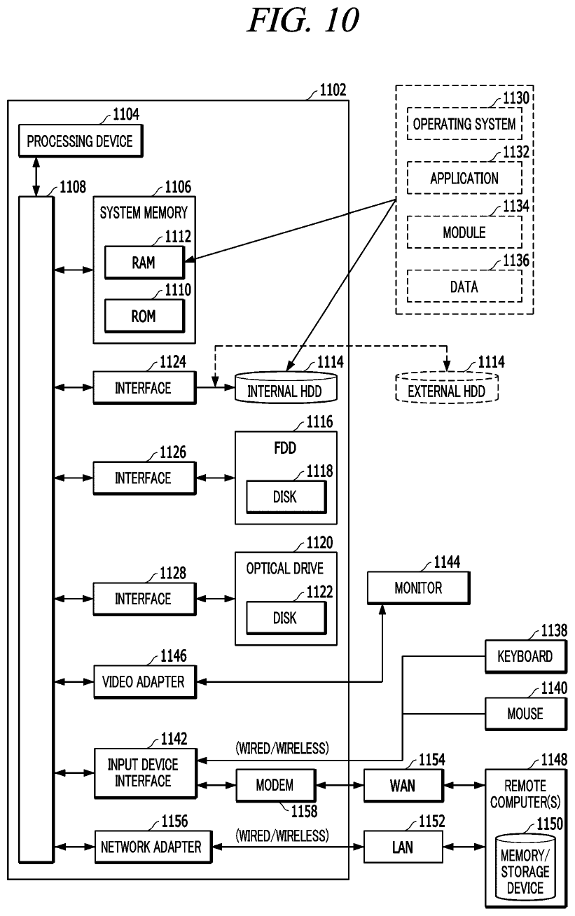

FIG. 10 is a block diagram of a computing device according to an embodiment of the present disclosure.

Although the present disclosure is generally described above with respect to computer-executable commands that may be executed by one or more computers, those skilled in the art will appreciate that the present disclosure may be implemented in combination with other program modules and/or by combining hardware and software.

In general, a program module includes a routine, a program, a component, a data structures, and so on that perform a particular task or a particular abstract data type. In addition, those skilled in the art will appreciate that the method according to the present disclosure may be implemented by other computer system configurations including a single-processor or multiprocessor computer system, a minicomputer, a mainframe computer, a personal computer, a handheld computing device, a microprocessor-based or programmable household appliance, and so on (each of these may operate in connection with one or more associated devices).

The embodiments according to the present disclosure may also be implemented in a distributed computing environment where certain tasks are performed by remote processing devices connected to each other through a communication network. In the distributed computing environment, program modules may be stored in both a local memory storage device and a remote memory storage device.

A computer typically includes a variety of computer-readable media. Any medium accessible by the computer may be a computer-readable medium. The computer-readable media include volatile and nonvolatile media, transitory and non-transitory media, and removable and non-removable media. By way of example without limitation, the computer-readable media may include computer-readable storage media and computer-readable transmission media. The computer-readable storage media include volatile and nonvolatile media, transitory and non-transitory media, removable and non-removable media implemented by any method or technology for storing information such as computer readable commands, data structures, program modules, or other data. A computer storage medium includes RAM, ROM, EEPROM, flash memory or other memory technologies, compact disk read only memory (CD-ROM), a digital video disk (DVD), an optical disk storage device, a magnetic cassette, a magnetic tape, a magnetic disk storage device, other magnetic storage device, or any other medium that may be accessed by a computer and used to store desirable information but is not limited thereto.

The computer-readable transmission media typically include any information transmission media, which implement computer-readable commands, data structures, program modules, or other data in a modulated data signal, such as other transport mechanism. the term “modulated data signal” refers to a signal in which one or more of the characteristics of a signal are set or changed so as to encode information in the signal. By way of example without limitation, the computer-readable transmission media includes wired media such as a wired network or direct-wired connection, and wireless media such as acoustic media, radio frequency (RF) media, infrared media, or other wireless media. A combination of any of the above-described media is also included in the scope of the computer-readable transmission media.

An example environment 1100 including a computer 1102 for implementing various aspects of the present disclosure is illustrated, the computer 1102 includes a processing device 1104, a system memory 1106, and a system bus 1108. The system bus 1108 connects the system memory 1106 (not limited to this) and system components to the processing device 1104. The processing device 1104 may be any of a variety of commercially available processors. Dual processors and other multiprocessor architectures may also be used as the processing device 1104.

The system bus 1108 may be any of several types of bus structures that may be additionally interconnected to a memory bus, a peripheral bus, and a local bus using any of a variety of commercial bus architectures. The system memory 1106 includes a ROM 1110 and a RAM 1112. A basic input/output system (BIOS) is stored in the nonvolatile memory 1110 such as ROM, EPROM, EEPROM, or so on, and the BIOS is a basic routine that helps information transmission between components in the computer 1102 at the time of startup or so on. The RAM 1112 may also include high speed RAM such as static RAM for caching data.

The computer 1102 also includes an internal hard disk drive (HDD) 1114 (for example, enhanced integrated drive electronics (EIDE) or serial advanced technology attachment (SATA)—the internal hard disk drive 1114 may also be used as an external device in a suitable chassis (not illustrated)), a magnetic floppy disk drive (FDD) 1116 (for example, for reading data from or writing data to a movable diskette 1118), and an optical disk drive 1120 (for example, for reading data from a CD-ROM disk 1122 or for reading data from or writing data to other high-capacity optical media such as DVD). The hard disk drive 1114, the magnetic disk drive 1116, and the optical disk drive 1120 are each connected to a system bus 1108 by a hard disk drive interface 1124, a magnetic disk drive interface 1126, and an optical drive interface 1128, respectively. The hard disk drive interface 1124 for implementing an external drive includes at least one or both of Universal Serial Bus (USB) and IEEE 1394 interface technology.

The drives and computer readable media associated thereto provide non-volatile storage of data, data structures, computer executable commands, and so on. In the computer 1102, drives and media correspond to storing any data in a suitable digital format. Although the computer-readable medium described above refers to a movable optical medium such as a HDD, a movable magnetic disk, and a CD or DVD, those skilled in the art may appreciate that other types of media readable by a computer, such as a zip drive, a magnetic cassette, a flash memory card, or a cartridge may also be used in an example operating environment and that any such media may include computer executable commands for performing the methods according to the present disclosure.

Multiple program modules including an operating system 1130, one or more application programs 1132, other program modules 1134, and program data 1136 may be stored in the drive and the RAM 1112. All or some of the operating system, the applications, the modules, and/or the data may also be cached in the RAM 1112. It will be appreciated that the present disclosure may be implemented by a commercially available operating system or a combination of operating systems.

A user may input a command and information to the computer 1102 by using one or more wired/wireless input devices, for example, a pointing device such as a keyboard 1138 or a mouse 1140. Other input devices (not illustrated) may include a microphone, an infrared (IR) remote control, a joystick, a game pad, a stylus pen, a touch screen, and so on. These and other input devices are often connected to the processing unit 1104 through an input device interface 1142 connected to the system bus 1108 but may be connected by other interfaces such as a parallel port, an IEEE 1394 serial port, a game port, a USB port, and an IR interface.

A monitor 1144 or another type of display device is also connected to the system bus 1108 through an interface such as a video adapter 1146. In addition to the monitor 1144, the computer generally includes other peripheral output devices (not illustrated) such as a speaker, a printer, and so on.

The computer 1102 may operate in a networked environment using logical connections to one or more remote computers such as remote computer(s) 1148 through wired and/or wireless communication. The remote computer(s) 1148 may be a workstation, a computing device computer, a router, a personal computer, a portable computer, a microprocessor-based entertainment device, a peer device, or other common network nodes, and includes many or all of the components generally described on the computer 1102, but for the sake of simplicity, only a memory/storage device 1150 is illustrated. The illustrated logical connections include wired/wireless connections to a local area network (LAN) 1152 and/or a larger network, for example, a wide area network (WAN) 1154. LAN and WAN networking environments are common in offices and companies and facilitate an enterprise-wide computer network such as an intranet, and all of which may be connected to a worldwide computer network, for example the Internet.

When used in a LAN networking environment, the computer 1102 is connected to the local network 1152 through a wired and/or wireless communication network interface or an adapter 1156. The adapter 1156 may facilitate wired or wireless communication to the LAN 1152 which also includes a wireless access point installed therein to communicate with the wireless adapter 1156. When used in a WAN networking environment, the computer 1102 may include a modem 1158 or may be connected to a communication computing device on the WAN 1154 or may have another device that establishes communication through the Internet or the WAN 1154. The modem 1158, which may be an internal or external device and a wired or wireless device, is connected to the system bus 1108 through the input device interface 1142. In a networked environment, program modules described on the computer 1102 or some of the program modules may be stored in a remote memory/storage device 1150. It will be appreciated that the illustrated network connection is an example and other devices for establishing a communication link between computers may be used.

The computer 1102 may communicate with any device or place, and a phone associated with any wireless device or object that performs wireless communication, such as a printer, a scanner, a desktop and/or portable computer, a portable data assistant (PDA), a communication satellite, or a wireless detectable tag. This includes at least Wi-Fi and Bluetooth wireless technologies. Accordingly, the communication may have a predefined structure as in a network of the related art or may simply be ad hoc communication between at least two devices.

Wi-Fi (Wireless Fidelity) makes it possible to be connected to the Internet or so on without a wire. Wi-Fi is a wireless technology such as a cell phone that allows a device, for example a computer to transmit and receive data indoors and outdoors, that is, anywhere within a coverage region of a base station. A Wi-Fi network uses a wireless technology called IEEE 802.11 (a, b, g, and so on) to provide a secure, reliable and high-speed wireless connection. Wi-Fi may be used to connect computers to each other, to the Internet, and to a wired network (using IEEE 802.3 or Ethernet). The Wi-Fi network may operate in unlicensed 2.4 and 5 GHz radio bands, for example at a data rate of 11 Mbps (802.11a) or 54 Mbps (802.11b) or may operate in products that include both bands (dual bands).

Those skilled in the art of the present disclosure will understand that information and signals may be represented by using any of a variety of different technologies and techniques. For example, data, instructions, commands, information, signals, bits, symbols and chips that may be referenced in the above description may be represented by voltages, currents, electromagnetic waves, magnetic fields or particles, optical fields or particles, or any combination thereof.

Those skilled in the art of the present disclosure will appreciate that various illustrative logical blocks, modules, processors, means, circuits and algorithm steps described in connection with the embodiments disclosed herein may be implemented by electronic hardware (referred to herein as “software” for the sake of convenience), various programs or design codes, or a combination of thereof. In order to clearly describe interchangeability of hardware and software, various illustrative components, blocks, modules, circuits, and steps are described above generally in terms of their functionality. Whether or not the functionality is implemented by hardware or software depends on a particular application and design limitations imposed on the overall system. Those skilled in the art of the present disclosure may implement the functions described in various ways for each specific application, but determination of the implementation should not be interpreted as causing a departure from the scope of the present disclosure.

The various embodiments presented herein may be implemented as a method, an apparatus, or an article of manufacture article using standard programming and/or an engineering technique. A term “article of manufacture” includes a computer program or a medium accessible from any computer-readable device. For example, a computer-readable medium includes a magnetic storage device (for example, hard disk, floppy disk, magnetic strip, or so on), an optical disk (for example, compact disk (CD), digital versatile disk (DVD), or so on), a smart card, or a flash memory device (for example, erasable and programmable read only memory (EEPROM), card, stick, key drive, or so on) but is not limited thereto. In addition, the various storage media presented herein include one or more devices and/or other machine-readable media for storing information.

It will be appreciated that a specific order or hierarchy of steps in the presented processing is an example of illustrative approaches. it will be appreciated that the specific order or hierarchy of the steps in the processing may be rearranged within the scope of the present disclosure based on design priorities. The appended claims of a method provide elements of various steps in a sample order but are not limited to the specific order or hierarchy presented herein.

Descriptions of the presented embodiments are provided to enable any person skilled in the art to use or implement the present disclosure. Various modifications of the embodiments will be apparent to those skilled in the art. The general principles defined herein may be applied to other embodiments without departing from the scope of the present disclosure. Accordingly, the present disclosure is not limited to the embodiments presented herein and should be construed in the widest scope consistent with the principles and novel characteristics presented herein.

What is claimed is:

1. A non-transitory computer-readable storage medium comprising:
a user interface configured to display data when a computer program stored in the non-transitory computer-readable storage medium is executed by one or more processors of a computing device;
a version tree layer included in the user interface and configured to display a version tree including a main tree composed of one or more versions and a subtree composed of one or more subversions; and
a data display layer included in the user interface and configured to display data corresponding to a selectively inputted subversion in response to a selective input for at least one subversion included in the version tree.

2. The non-transitory computer-readable storage medium of claim 1, wherein two or more versions included in the main tree have a precedence relationship, and two or more subversions included in the subtree have a parallel relationship.

3. The non-transitory computer-readable storage medium of claim 1, wherein each of the one or more versions included in the main tree is a subversion selected from the one or more subversions included in the subtree.

4. The non-transitory computer-readable storage medium of claim 1, wherein the version tree layer displays only versions corresponding to the main tree in response to a simple view input for viewing a simplified version tree.

5. The non-transitory computer-readable storage medium of claim 1, wherein the version tree layer displays a major update on a version of data having a change of more than a threshold when compared with data of a previous version.

6. The non-transitory computer-readable storage medium of claim 5, wherein the version tree layer displays only versions corresponding to the major update except for versions not corresponding to the major update, in response to a major update view input for viewing simplified versions corresponding to the major update.

7. The non-transitory computer-readable storage medium of claim 1, wherein the user interface further includes a data comparison layer configured to compare two or more pieces of data corresponding to two or more versions, respectively, and display the compared results in response to a comparison input for the two or more versions included in the version tree to compare the two or more pieces of data.

8. The non-transitory computer-readable storage medium of claim 7, wherein
the data comparison layer overlaps and displays first data corresponding to a first version and second data corresponding to a second version,
the first data is displayed on an upper side in one region based on an axis such that the second data is not displayed, and the second data is displayed on an upper side in another region based on the axis such that the first data is not displayed, and
a size of the one region in which the first data is displayed on the upper side is expanded to be displayed, and a size of another region in which the second data is displayed on the upper side is reduced to be displayed in response to a movement input for moving the axis.

9. The non-transitory computer-readable storage medium of claim 7, wherein the data comparison layer adjusts a visualization method for at least one of first data corresponding to a first version and second data corresponding to a second version and displays the adjusted visualization method in response to an adjustment input regarding a visualization adjustment object.

10. The non-transitory computer-readable storage medium of claim 8, wherein the data comparison layer adjusts a visualization method for at least one of the first data and the second data in response to an adjustment input in a direction different from the movement input, regarding a visualization adjustment object displayed on the axis.

11. The non-transitory computer-readable storage medium of claim 7, wherein the data comparison layer displays annotations for a changed portion between data.

12. The non-transitory computer-readable storage medium of claim 11, wherein the processor generates data of a new version to which changes of a portion corresponding to a change confirmation input among the annotations are applied, in response to the change confirmation input for an annotation.

13. The non-transitory computer-readable storage medium of claim 1, wherein the version tree layer updates the version tree such that new data is included in a position corresponding to a version input for the new data and displays the updated version tree, based on the new data and the version input for the new data.

14. The non-transitory computer-readable storage medium of claim 1, wherein the version tree layer updates the version tree such that a subversion of new data is included in a position corresponding to a connection input and displays the updated version tree, in response to the connection input for connecting the new data to at least one of a version and a subversion included in the version tree.

15. The non-transitory computer-readable storage medium of claim 1, wherein
the version tree layer displays a comment object on at least some versions of the one or more versions, and
the user interface further includes a comment display layer for displaying comments included in the version tree in response to a comment view input for viewing the comments.

16. A method of displaying data in a user terminal, the method comprising:
displaying a version tree including a main tree composed of one or more versions and a subtree composed of one or more subversions, on a version tree layer; and
displaying data corresponding to a subversion that is selectively inputted on a data display layer in response to a selective input for at least one subversion included in the version tree.

17. A user terminal comprising:
a processor including one or more cores;
a memory; and
an output unit configured to provide a user interface,
wherein the user interface includes:
a version tree layer configured to display a version tree including a main tree composed of one or more versions and a subtree composed of one or more subversions; and
a data display layer configured to display data corresponding to a selectively inputted subversion in response to a selective input for at least one subversion included in the version tree.
